(19) United States
(12) Patent Application Publication
(10) Pub. No.: US 2002/0044207 A1
(43) Pub. Date: Apr. 18, 2002

(54) Front-end device for CCD with hybrid sampler

(76) Inventors: Pieter Bastiaan Dielhof, Eindhoven (NL); Petrus Gijsbertus Maria Centen, Breda (NL); Richard Morisson, Caen (FR)

Correspondence Address: Jack E. Haken, U.S. Philips Corporation, 580 White Plains Road, Tarrytown, NY, 10591, US

(21) Appl. No.: 09/826,620

(22) Filed: Apr. 5, 2001

(30) Foreign Application Priority Data
Apr. 6, 2000 (EP) 00201261.5

(51) Int. Cl. H04N 9/64

(52) U.S. Cl. 348/251

(57) ABSTRACT

Front-ends for CCD cameras are known which use a clamping part and a sampling part using parallel arrangement of a coil and a resistor. As coils are almost always bulky they can not be integrated.

The invention proposes a new front end and a new sampling circuit for use in such a front end which does not need the use of such coil, and so making it possible to integrate the sampling part.

The invention relates to a front-end device as described in the preamble of claim 1. The invention further relates to a sampling circuit for use in such a front-end device. The invention further relates to a CCD camera comprising such a front-end device.

Front-end devices for use in a CCD camera are known in the art. Such front-end devices normally comprise sampling circuit for sampling the analog input signal from a CCD sensor and supplying a sampled output signal to an A/D converter.

For example from U.S. Pat. No. 5,554,944 a sampling circuit is known for use in such a front-end device. This sampling circuit comprises a clamping part for clamping a received input signal and a sampling part for sampling this clamped input signal. To improve noise reduction capabilities and to make it possible to use sampling frequencies above 10 MHz the sampling circuits comprise a parallel arrangement of a coil and a resistor.

One of the disadvantages of this known sampling circuit is the use of coils in the sampling circuit. Because the use of coils it is impossible to integrate this part of the sampling circuit, and so making the circuit very bulky. Further the known sampling circuit is very sensitive to component spread.

It is inter alia an object of the invention to provide a sampling circuit, front-end device and CCD camera which have further improved noise reduction capabilities and a capability of operating and sampling frequencies above 10 MHz, which however also comprises a sampling circuit which can be integrated. To this end a first aspect of the invention provides a front-end device comprising the features of claim 1.

A second aspect of the invention provides a sampling circuit as described in claim 6. Such a sampling circuit can be used in different devices.

A third aspect of the invention provides a CCD camera as described in claim 7. For example this CCD camera according to the invention can be used in security cameras.

The sampling circuit according to the invention comprises a variable capacitor of which the capacitance varies in dependence of the input frequency. In this way it is possible to integrate the pixel level with a minimum bandwidth and so to limit noise addition caused by higher spectral components. For this purpose an integrator has to be tuned to the aperture time of the application.

Embodiments of the invention are described in the dependent claims.

The invention and additional features, which may be optionally used to implement the invention to advantage, will be apparent from and elucidated with reference to the examples described below, hereinafter and shown in the figures. Herein shows

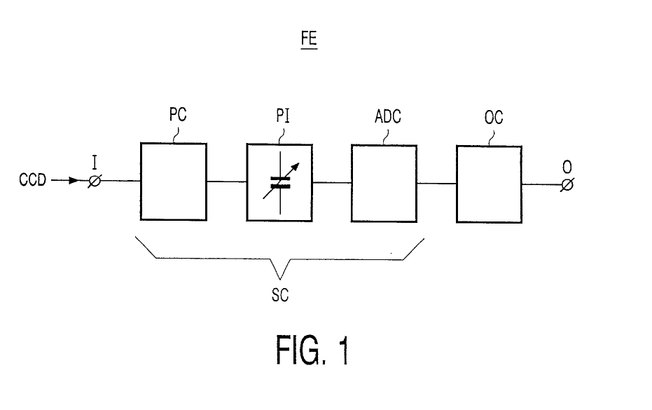

FIG. 1 a schematic example of a front-end device according to the invention,

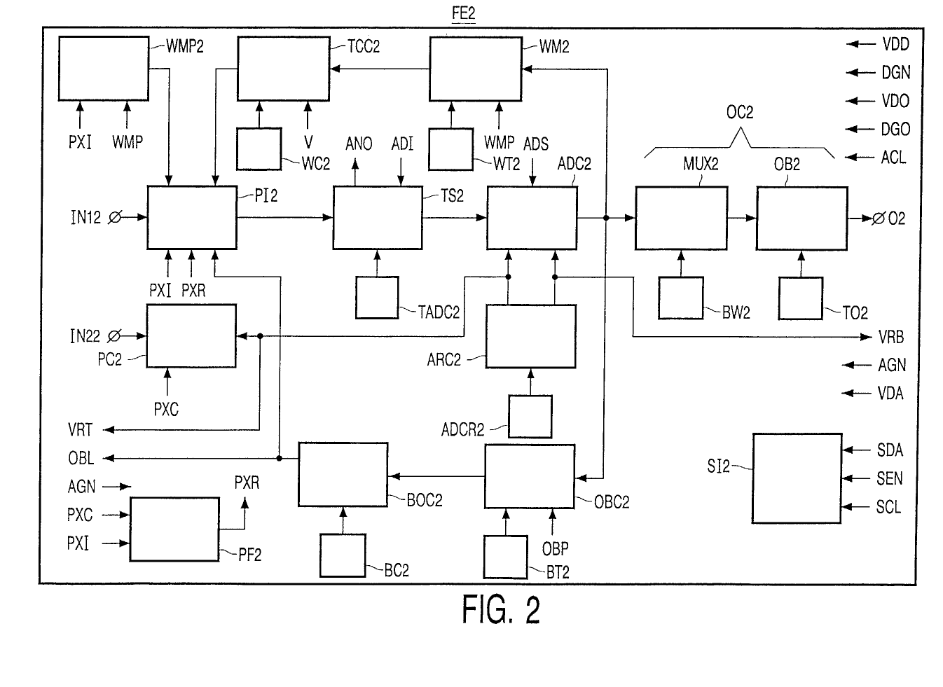

FIG. 2 a more detailed schematic example of a front-end device according to the invention,

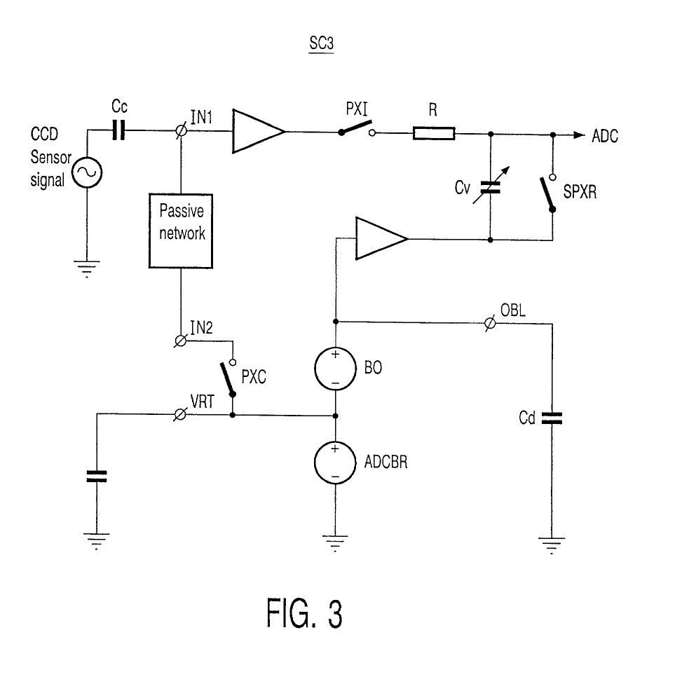

FIG. 3 a schematic example of a sampling circuit according to the invention,

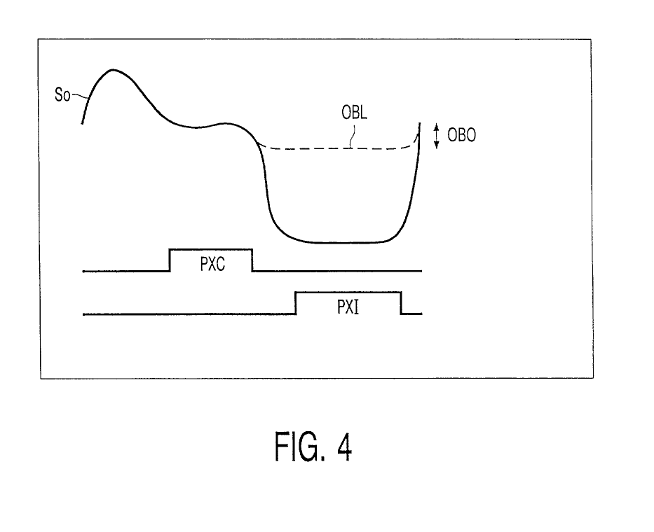

FIG. 4 a timing diagram of the black level control,

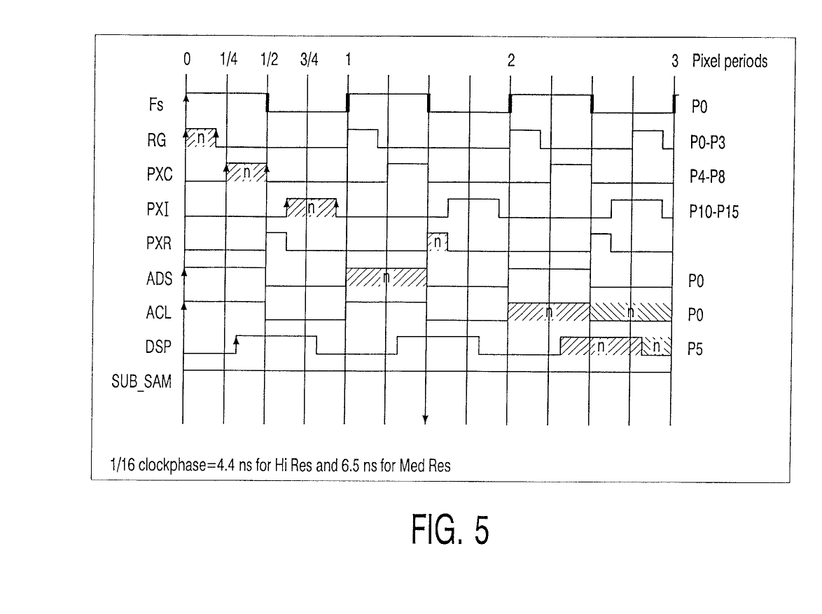

FIG. 5 a timing diagram of the front-end device of FIG. 2,

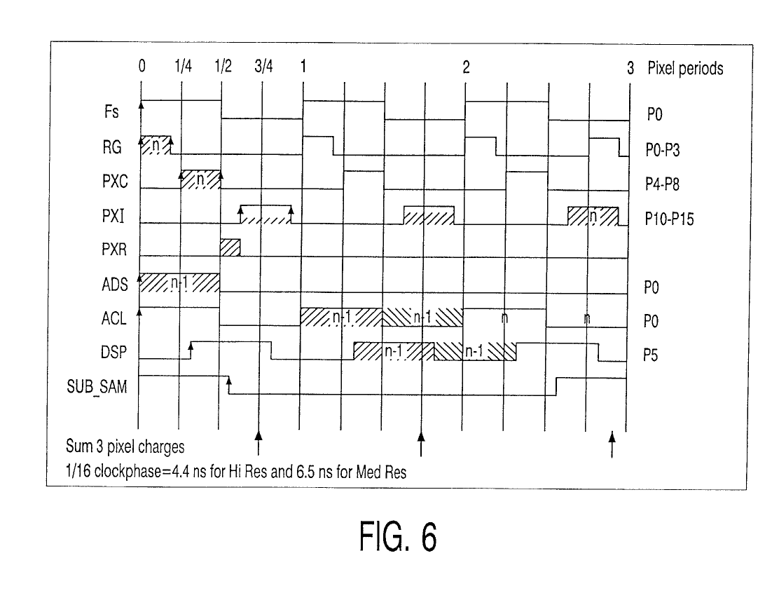

FIG. 6 a second timing diagram of the front-end device of FIG. 2,

FIG. 1 shows a first schematic example of a front-end device FE according to the invention. At an input I this front end device receives an analog signal from a CCD sensor. A sampling circuit SC is coupled to the input and comprises a pixel clamp part PC and a pixel integration part PI. After integration the signal is supplied to an A/D converter ADC for converting the signal into a digital signal. The A/D converter is coupled via an output circuit OC to the output O of the front-end device.

The main function of the front-end device is to perform optimal filtering of the sensor signal in order to remove reset- and LF noise and to convert the analog (video) signal to a for example 15 bits digital format. Further the black level has to be controlled to a predefined value and a gain has to be kept to a predefined value.

FIG. 2 shows in more detail a schematic example of a front-end device FE2 according to the invention. On an input IN12 a signal from the CCD sensor is received. The input IN12 is coupled to a pixel integrator and reset circuit PI2 which receives as inputs further the signals PXI, PXR and a signal from a black offset control circuit BOC2. The output of the pixel integrator and reset circuit is coupled to a test switch circuit TS2 for testing the A/D converter ADC2. The test switch circuit further receives a test signal from a test ADC circuit TADC2, and a signal ADI. The test switch circuit further supplies a signal ANO.

The A/D converter further receives a signal ADS. The output of the A/D converter is coupled to the output circuit OC2 comprising in this example of a multiplex circuit MUX2 and an output buffer OB2 coupled to the output O2. The multiplex circuit further receives a signal from a bit width circuit BW2. The output buffer further receives a signal from a test output circuit TO2 during testing.

The A/D converter ADC2 receives at other inputs signals from an ADC reference control circuit ARC2 which ADC reference control circuit receives at an input a signal from an ADC range circuit ADCR2.

The input IN22 is coupled to a pixel clamp circuit PC2 which receives at another input the signal PXC. The pixel clamp circuit PC2 also receives an input signal from the ADC reference control circuit ARC2.

The pixel integrator and reset circuit PI2 also receives an input signal from a white measure pulse circuit WMP2. Further the pixel integrator and reset circuit PI2 receives an input signal from a time constant control circuit TCC2, which time constant control circuit receives as input signal a signal from a white calibration circuit WC2 and a signal V. The output of the A/D converter ADC2 is also coupled to a white measuring circuit WM2 which circuit supplies a signal to the time constant control circuit TCC2. The white measurement circuit further receives a signal from a white target circuit WT2 and a signal WMP.

Further the output of the A/D converter is also coupled to an optical black clamp circuit OBC2, which circuit is coupled to the black offset control circuit BOC2. The optical black clamp circuit OBC2 receives at an input a signal from a black target circuit BT2 and a signal OBP.

Further the front-end of this example comprises a serial interface SI2.

The different signals and their timing relation is shown in FIGS. 5 and 6 as described hereinafter.

FIG. 3 shows an example of the sampling circuit SC3. The correlated filter function is not a conventional so called S&H, but a so-called Clamp & Integrate circuit with reset. The Pixel Clamp has a double function; primarily set the pixel reference for the integrator in order to cancel reset- and LF noise and secondly set this reference to the reference black level of the ADC.

The pixel clamp input (IN2) can be connected directly to IN1. In this case the pixel clamp operates fast just like a normal sample and hold.

Alternatively input IN2 can be connected via a passive network PN to IN1 in which case the pixel clamp operates as a passive integrator in order to minimize the addition of noise components from repeat spectra.

The pixel integrator is realized as a first order RC network (R and Cv), where the RC time is nearly equal to the aperture time. As such it integrates the pixel level with a minimum bandwidth and so it limits noise addition caused by higher spectral components. For this purpose the integrator has to be tuned to the aperture time of the application. Tolerances and temperature drift of the RC time have to be compensated for. This tuning is performed by the variable capacitor Cv.

As the pixel integrator never reaches a full step acquisition during the aperture time—the capacitor has to be reset with switch SPXR after each charge in order to overcome charge from a preceding pixel to add to next pixel. This reset takes place just after the pixel contents transfer to the A/D converter ADC and before the next pixel integration will start. The reset pulse is made internally starting at the falling edge of the pixel clamp pulse (PXC) and stopping at the rising edge of the pixel integrate pulse (PXI). (See FIG. 4 for the timing and sensor output signal So.)

An optical black loop controls the optical black level OBL as reference for the pixel reset. It aims to offset this reference that much as to compensate for optical black offsets OBO in the signal.

The advantage is that the voltage difference over the integration capacitor for optical black is minimal and hence the variance on black level due to timing jitter is minimal. Additionally there is generally some extra offset (set with Black target) used in order to keep the total noise just above the ADC black reference to prevent clipping (See FIG. 4).

The optical black loop averages the A/D converter ADC output values during the optical black clamp and compares the level with an adjustable target value. A difference causes an update of the level on the de-coupling capacitor Cd at pin OBL (Optical Black Level), until it reaches the measured optical black level at the ADC output. This update operates during OBP (Optical Black Pulse) pulse only. The OBP pulse has a programmable start and stop edge, controlled by the timing generator of the digital signal processor DSP. The Black target can be loaded via the serial interface SI (see FIG. 2).

A calibration loop keeps the RC product (R and Cv) of the pixel integrator constant over tolerances and temperature. Two ranges are available in this example, one for so called MR and the other for so called HR sensors with the related pixel frequencies. A burst of white reference pixels is inserted onto the video signal, composed by the so-called White Measure Pulse WMP and PXI. The resulting white pixels at ADC out are averaged during the WMP and compared with an adjustable target value. A difference causes a process to update the addresses for the relevant amount of capacitors in the integrator array. After each update the total capacitance increases or decreases in order to follow the target value. The WMP pulse has a programmable start and stop edge, controlled by the timing generator of the DSP. The White target can be loaded via the serial interface. The update can take place at line base (start mode) or at field base. The control process can be reset or halted via the serial interface. In the register a preferred nominal or test value can be loaded via the serial interface. This implementation of the white calibration loop is an example.

After each pixel integration, the output will be sampled into the A/D converter ADC. This will be done during the ADS pulse which is as long as possible in order to keep the sampling bandwidth as low as possible. Again, for reducing the addition of noise components from repeat spectra.

The ADC ladder is adjustable via the serial interface to adapt different sensor saturation levels in which case the White target level will change accordingly.

A switch can separate the analog output from the Buffer to the ADC via a serial interface command in order to test the analog and digital part separately. The test input and output lines can be switched off via the serial interface in order to overcome EMC problems.

The multiplexer converts the output from a 15 to a 10 wire format. A test vector can be loaded via the serial interface. The Serial Interface Bus gets data only during vertical interval, under control of the DSP.

All input pulses are in this example as indicated, except PXR, are defined externally and will be programmed by the timing generator of the DSP. Their relative timing shall not be changed internally in order to keep the programmed functionality.

The timing from the pulse pattern generator distinguishes two modes of operation: normal operation and sub-sampling operation. In normal operation several types of sensors will be handled, all with pixel frequencies according to this specification, roughly split in Hi-Res and Med-Res sensors. In sub-sampling mode the pixel contents of two or more pixels has been added in the sensor output in order to increase the sensitivity.

The timing diagram of FIG. 5 shows the situation for normal operation. The pulse edges are defined by the PPG in the DSP. The grid is 16 phases of the pixel clock. As such all pulses are programmable. The edges are defined with a programmable delay line. In this way all edges has a fixed relationship to the first edge of the pixel clock in order to minimize jitter. Arrows in the diagram show this relation. The nominal phases (Px-Py) for start and stop are shown after each pulse. The forward hatched pulses show the processing stream for corresponding pixel contents. Note that the output stream with ADC contains data for the 10 MSBs, while the backward hatched pulses represent the 5 LSBs. The PXR pulse has to be created internally in the front-end starting at the falling edge of the PXC pulse and ending at the rising edge of the PXI pulse.

In the next time diagram, FIG. 6, the situation with an example of sub-sampling (3 times) is shown. Here the pixel content is read out the normal way, but the charge is collected on the floating diffusion capacitor in the sensor by suppressing RG. Now also PXC and PXR have to halt and the data to the ADC has to be read once in three pixel periods. The ADC output repeats the same value three times. The effect is a higher sensitivity (three times in the example) at the expense of resolution. The PXI pulse continues in order to keep the sampling rate and the necessary bandwidth for the integrator constant. Now the charge on the pixel integrator builds-up until the last pulse and is read out with ADS. Note that in the diagram the pixel contents as shown in the lower lines is from a preceding pixel combination.

1. Front-end device for a CCD camera, with an input for receiving an analog input signal with an input frequency from a CCD sensor, an output for supplying a digital output signal and comprising a sampling circuit for clamping the input signal and for sampling the claimed signal and an AD converter for converting the sampled signal into a digital signal, characterized in that the sampling circuit comprises a variable capacitor which value depends on the input frequency of the input signal and aperture time of the sample pulse.

2. Front-end device as claimed in claim 1, characterized in that the sampling circuit comprises resetting means for resetting the variable capacitor.

3. Front-end device as claimed in claim 1, characterized in that the sampling circuit comprises a white level control loop.

4. Front-end device as claimed in claim 1, characterized in that the sampling circuit comprises a black level control loop coupled to the variable capacitor.

5. Front-end device as claimed in claim 4, characterized in that the black level control loop minimizes the voltage difference over the variable capacitor for optical black.

6. Sampling circuit for use in a front-end device according to claim 1.

7. CCD camera comprising a front-end device as claimed in claim 1.
